(19) United States
(12) Patent Application Publication
(10) Pub. No.: US 2026/0267652 A1
(43) Pub. Date: Sep. 10, 2026

(54) MULTI-THREADED DATA DEPENDENCIES

(71) Applicant: Arm Limited, Cambridge (GB)

(72) Inventors: Giacomo GABRIELLI, Cambridge (GB); Matthew James HORSNELL, Cambridge (GB); Syed Ali Mustafa ZAIDI, Cambridge (GB); Marton ERDOS, Cambridge (GB); Timothy Martin JONES, Cambridge (GB)

(73) Assignee: Arm Limited, Cambridge (GB)

(21) Appl. No.: 19/167,055

(22) PCT Filed: Feb. 27, 2024
(86) PCT No.: PCT/GB2024/050523

§ 371 Date: Sep. 19, 2025

(30) Foreign Application Priority Data
Mar. 23, 2023 (GB) 2304210.4

(51) Int. Cl. G06F 9/38; G06F 9/30

(52) U.S. Cl. CPC G06F 9/3851; G06F 9/3009; G06F 9/3838

(57) ABSTRACT

A data processing apparatus includes multithreaded processing circuitry to perform processing operations of a plurality of micro-threads, each micro-thread operating in a corresponding execution context defining an architectural state. Decoder circuitry responds to a first occurrence of a detach instruction to generate a first micro-thread in respect of a first block of instructions, and a second occurrence of the detach instruction to generate a second micro-thread in respect of a second block of instructions. The second block of instructions comprises a data dependency in respect of a resource accessed in the first block of instructions. Also provided is a data processing apparatus with input circuitry that receives input code with a first block of instructions and a second block of instructions. Output circuitry produces output code corresponding to the first block of instructions and the second block of instructions. Processing circuitry generates the output code based on the input code. The processing circuitry generates: a first hint instruction, within the output code corresponding to the first block of instructions, that indicates an availability of a resource, and a second hint instruction, within the output code corresponding to the second block of instructions, that indicates a requirement of the resource. The second block of instructions has a data dependency in respect of a resource accessed in the first block of instructions.

The present technique relates to data processing, particularly in a multi-threaded environment.

It is desirable to provide micro-architectural multi-threading environment. Being micro-architectural, the environment need not be visible to, or even known by, a programmer. As a consequence of this, however, data dependencies can be difficult to detect and respond to.

Viewed from a first example configuration, there is provided a data processing apparatus comprising: multithreaded processing circuitry to perform processing operations of a plurality of micro-threads, each micro-thread operating in a corresponding execution context defining an architectural state; and decoder circuitry responsive to a first occurrence of a detach instruction to generate a first micro-thread in respect of a first block of instructions, and a second occurrence of the detach instruction to generate a second micro-thread in respect of a second block of instructions, wherein the second block of instructions comprises a data dependency in respect of a resource accessed in the first block of instructions.

Viewed from a second example configuration, there is provided a method comprising: performing processing operations of a plurality of micro-threads, each micro-thread operating in a corresponding execution context defining an architectural state; responding to a first occurrence of a detach instruction to generate a first micro-thread in respect of a first block of instructions; and responding to a second occurrence of the detach instruction to generate a second micro-thread in respect of a second block of instructions, wherein the second block of instructions comprises a data dependency in respect of a resource accessed in the first block of instructions.

Viewed from a third example configuration, there is provided a non-transitory computer-readable medium to store computer-readable code for fabrication of a data processing apparatus comprising: multithreaded processing circuitry to perform processing operations of a plurality of micro-threads, each micro-thread operating in a corresponding execution context defining an architectural state; and decoder circuitry responsive to a first occurrence of a detach instruction to generate a first micro-thread in respect of a first block of instructions, and a second occurrence of the detach instruction to generate a second micro-thread in respect of a second block of instructions, wherein the second block of instructions comprises a data dependency in respect of a resource accessed in the first block of instructions.

Viewed from a fourth example configuration, there is provided a data processing apparatus comprising: input circuitry configured to receive input code comprising a first block of instructions and a second block of instructions; output circuitry configured to produce output code corresponding to the first block of instructions and the second block of instructions; and processing circuitry configured to generate the output code based on the input code, wherein the processing circuitry is configured to generate: a first hint instruction, within the output code corresponding to the first block of instructions, configured to indicate an availability of a resource, and a second hint instruction, within the output code corresponding to the second block of instructions, configured to indicate a requirement of the resource; and the second block of instructions comprises a data dependency in respect of a resource accessed in the first block of instructions.

Viewed from a fifth example configuration, there is provided a method comprising: receiving input code comprising a first block of instructions and a second block of instructions; producing output code corresponding to the first block of instructions and the second block of instructions; and generating the output code based on the input code, wherein the output code comprises: a first hint instruction, within the output code corresponding to the first block of instructions, configured to indicate an availability of a resource, and a second hint instruction, within the output code corresponding to the second block of instructions, configured to indicate a requirement of the resource; and the second block of instructions comprises a data dependency in respect of a resource accessed in the first block of instructions.

Viewed from a sixth example configuration, there is provided a non-transitory computer-readable medium to store computer-readable code for fabrication of a data processing apparatus comprising: input circuitry configured to receive input code comprising a first block of instructions and a second block of instructions; output circuitry configured to produce output code corresponding to the first block of instructions and the second block of instructions; and processing circuitry configured to generate the output code based on the input code, wherein the processing circuitry is configured to generate: a first hint instruction, within the output code corresponding to the first block of instructions, configured to indicate an availability of a resource, and a second hint instruction, within the output code corresponding to the second block of instructions, configured to indicate a requirement of the resource; and the second block of instructions comprises a data dependency in respect of a resource accessed in the first block of instructions.

The present technique will be described further, by way of example only, with reference to embodiments thereof as illustrated in the accompanying drawings, in which:

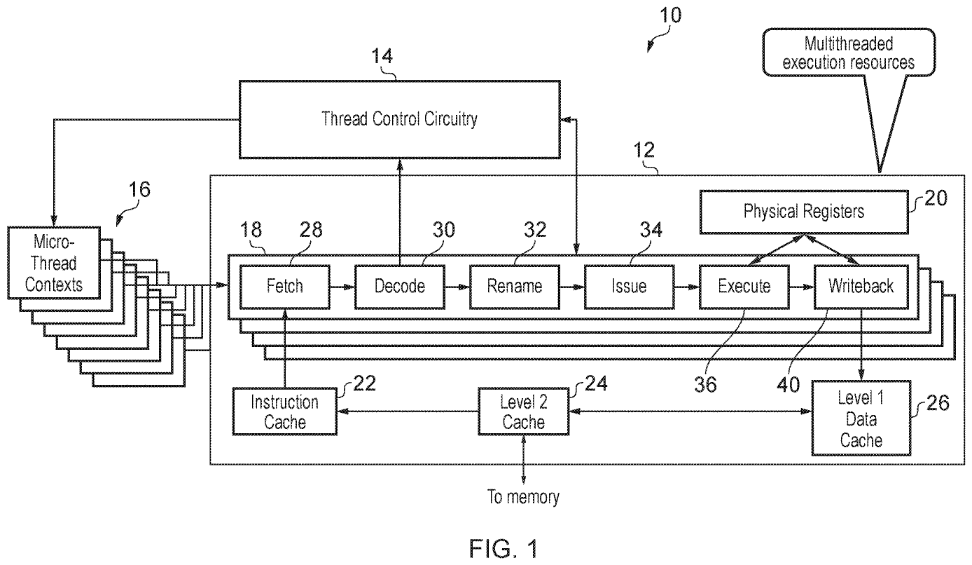

FIG. 1 schematically illustrates a data processing apparatus which may embody various examples of the present techniques;

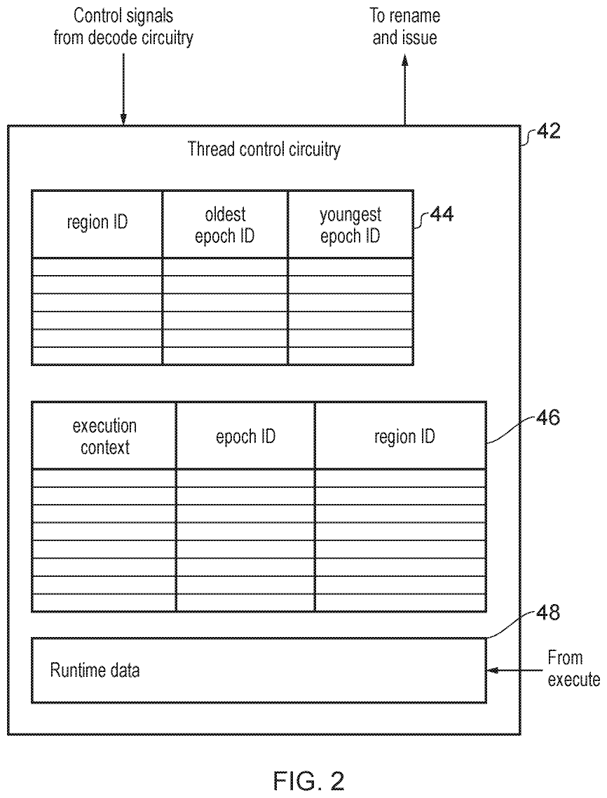

FIG. 2 schematically illustrates details of the operation of thread control circuitry which may embody various examples of the present techniques;

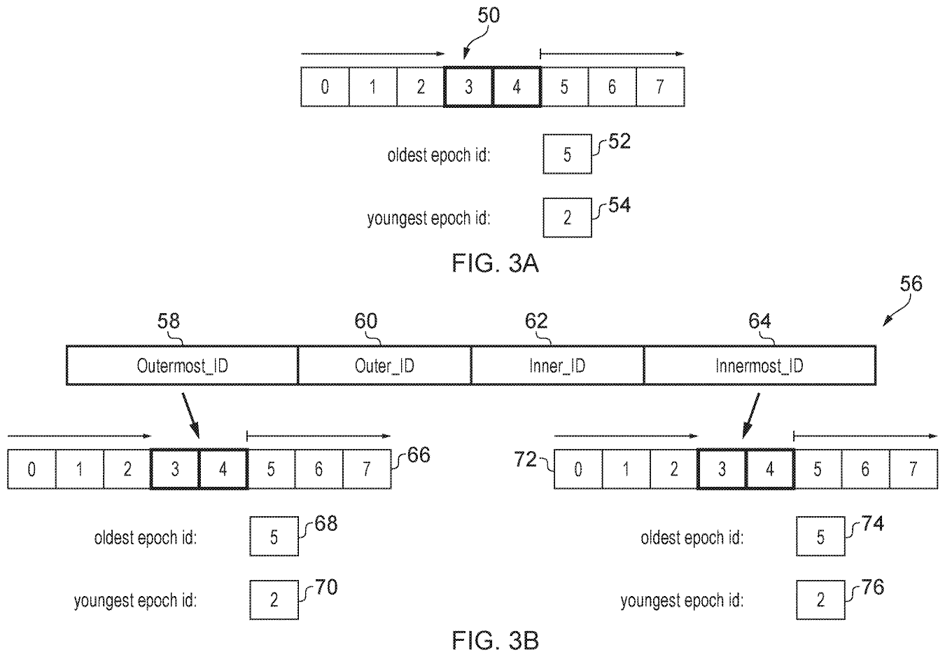

FIG. 3A schematically illustrates details of the assignment of epoch identifiers which may embody various examples of the present techniques;

FIG. 3B schematically illustrates details of the assignment of epoch identifiers which may embody various examples of the present techniques;

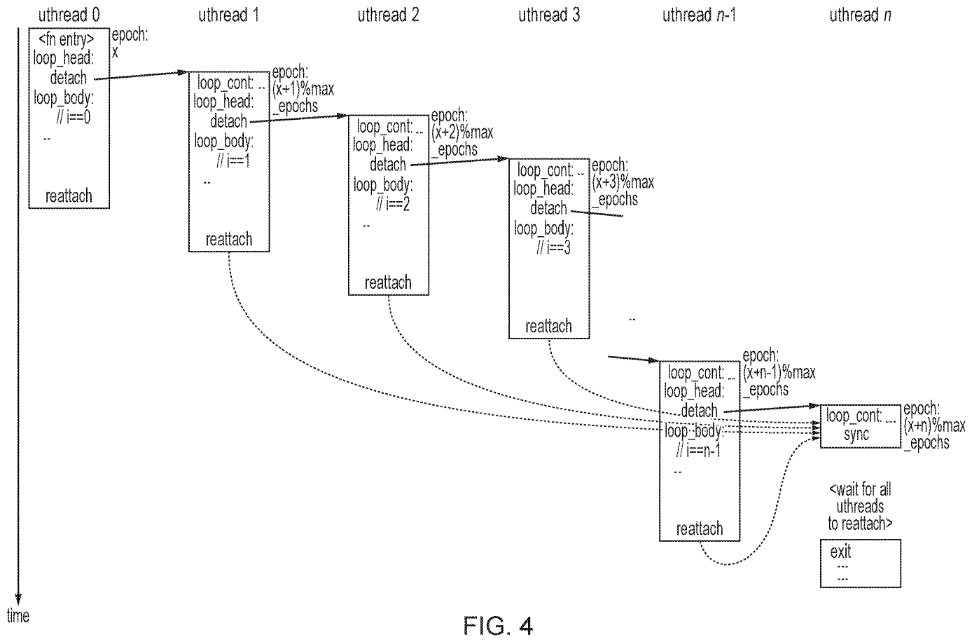

FIG. 4 schematically illustrates details of micro-thread execution which may embody various examples of the present techniques;

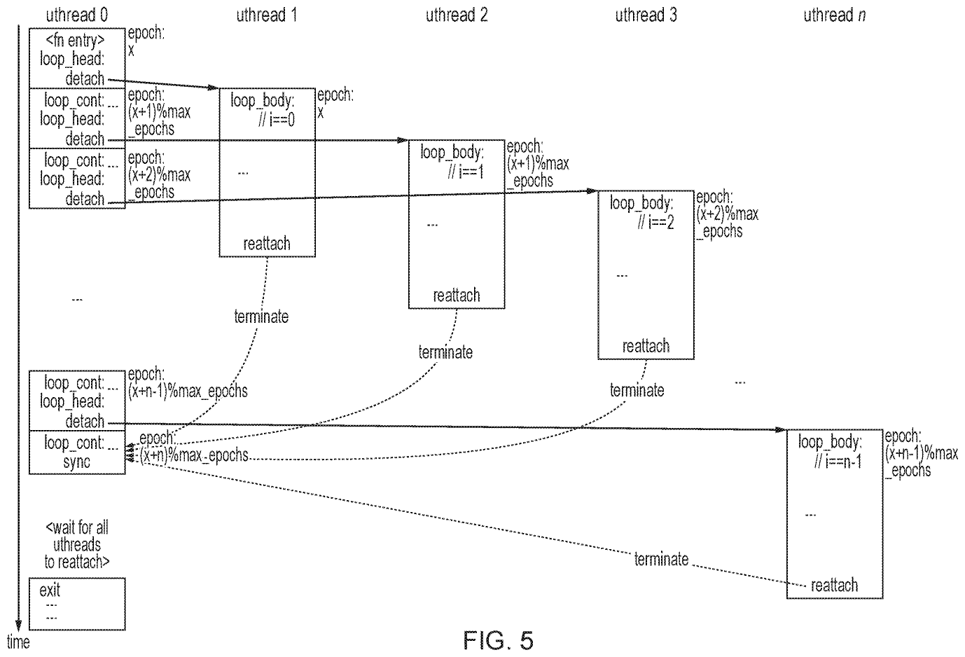

FIG. 5 schematically illustrates details of micro-thread execution which may embody various examples of the present techniques;

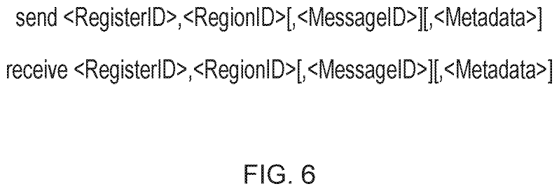

FIG. 6 illustrates an example of two hint instructions that help to overcome data dependency limitations;

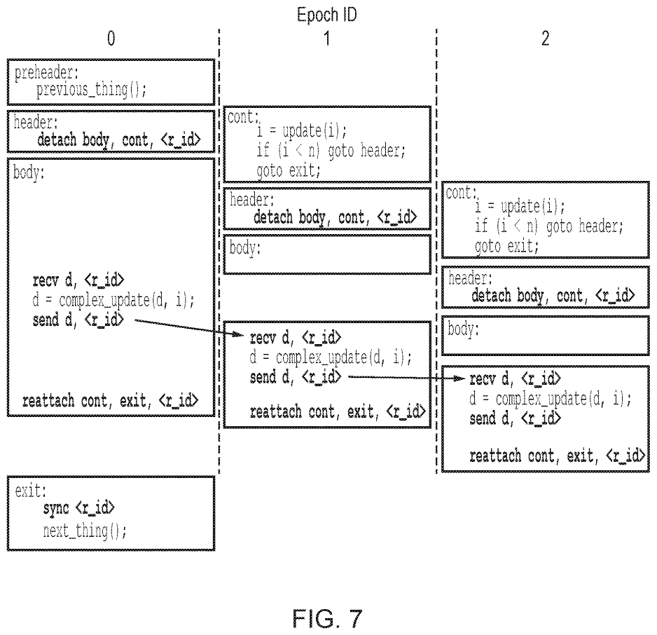

FIG. 7 illustrates an example of execution;

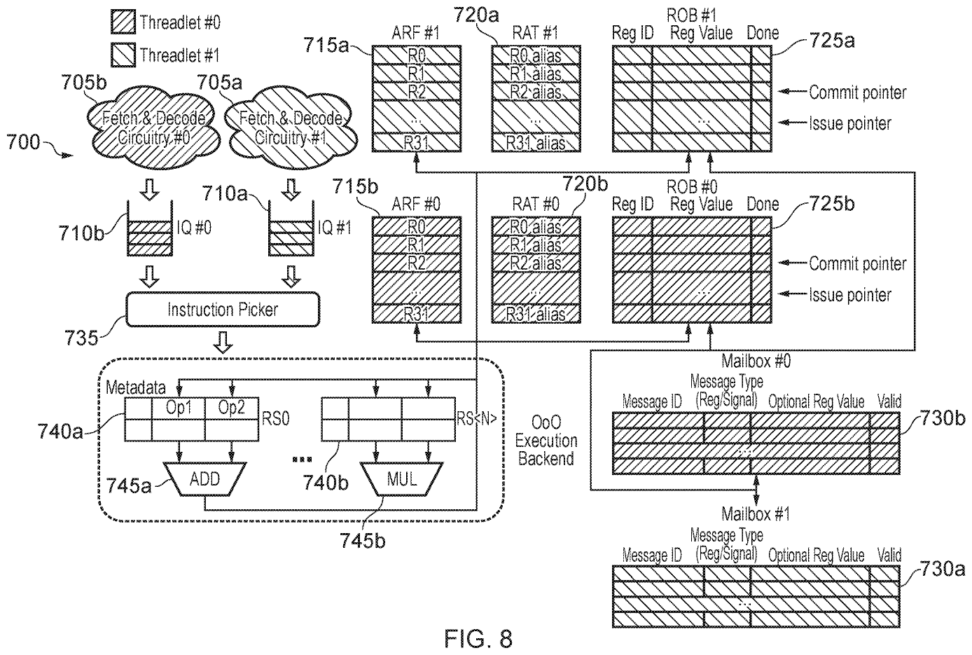

FIG. 8 illustrates a data processing apparatus implementation for handling two micro-threads;

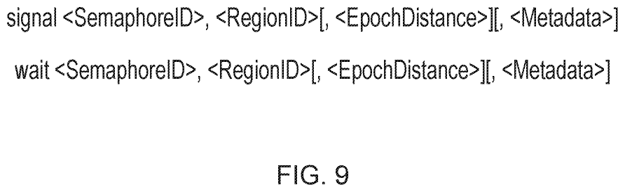

FIG. 9 illustrates two other hint instructions that can be used to indicate the availability of and desire for other resources such as memory addresses or blocks of code;

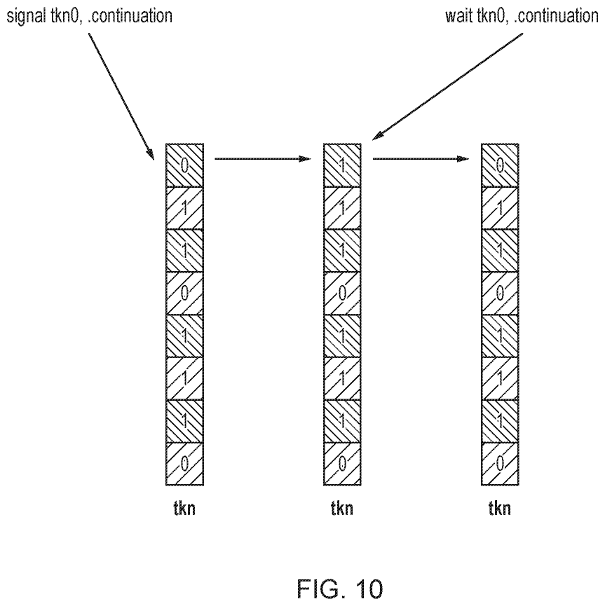

FIG. 10 shows an example of an 8-bit register (tkn) used to support 8 semaphores;

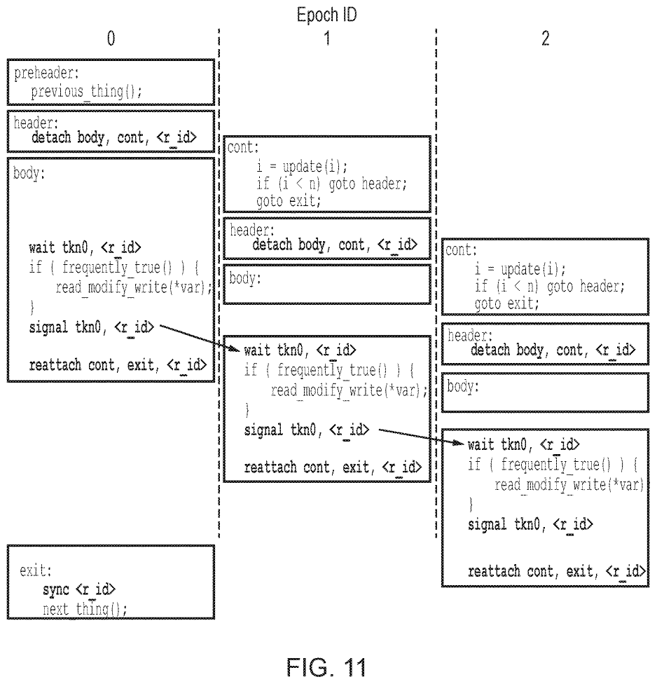

FIG. 11 illustrates another example of execution;

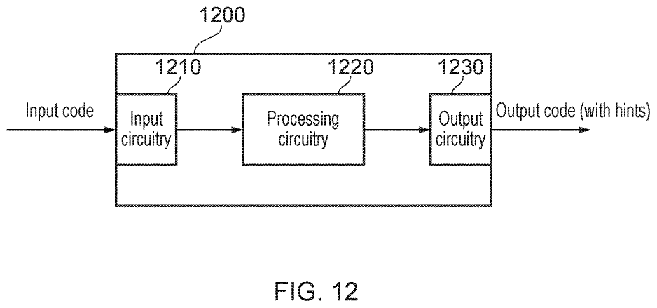

FIG. 12 illustrates a compiler;

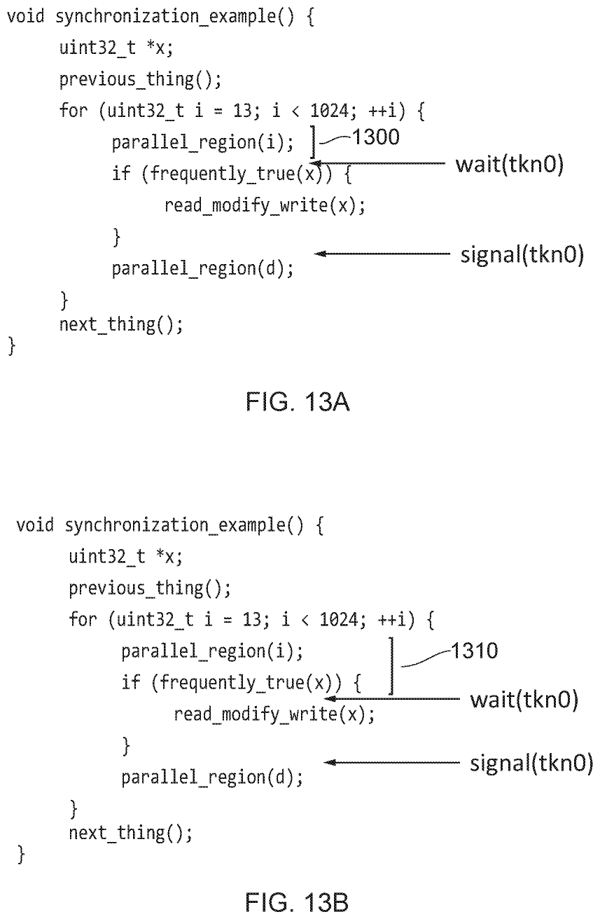

FIGS. 13A and 13B illustrate the behaviour of the compiler with respect to the placement of the hint instructions;

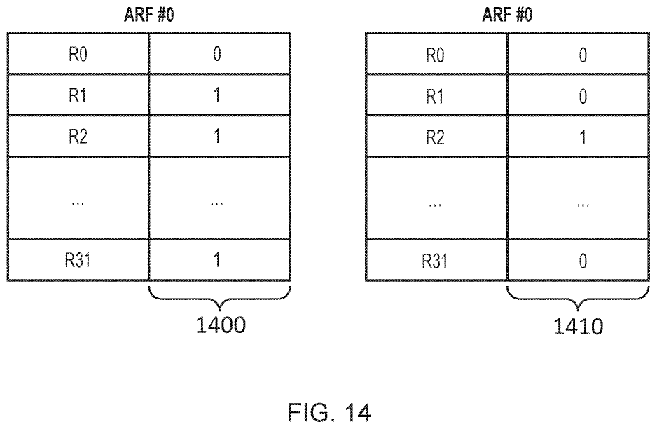

FIG. 14 illustrates another mechanism that can be used for handling dependencies; and

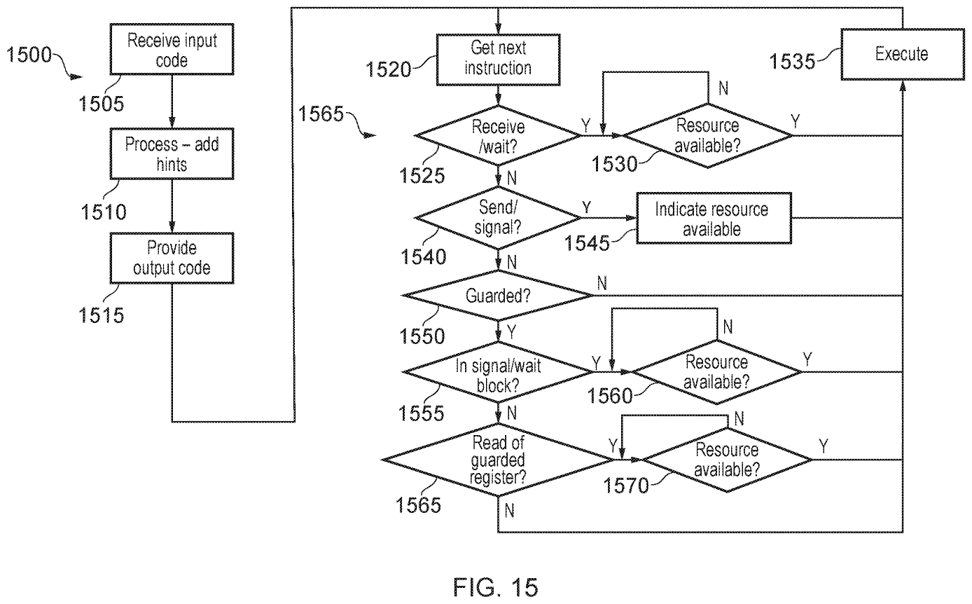

FIG. 15 illustrates a pair of flow charts.

Before discussing the embodiments with reference to the accompanying figures, the following description of embodiments and associated advantages is provided.

In accordance with one example configuration there is provided a data processing apparatus comprising: multithreaded processing circuitry to perform processing operations of a plurality of micro-threads, each micro-thread operating in a corresponding execution context defining an architectural state; and decoder circuitry responsive to a first occurrence of a detach instruction to generate a first micro-thread in respect of one iteration of a loop, and a second occurrence of the detach instruction to generate a second micro-thread in respect of another iteration of the loop, wherein the loop comprises a loop-carried data dependency in respect of a resource that extends across iterations of the loop. The creation of micro-threads via a detach instruction may be used in order to parallelise a task, such as executing the code belonging to a loop. Such parallelisation may be handled by the micro-architecture via the detach instruction and hence may be invisible to the operation system. Such parallelisation can be problematic in a loop in which a data dependence exists that extends across iterations of the loop. For instance, where data is required in one iteration of the loop that is provided in a previous iteration of the loop, it stands to reason that the previous iteration of the loop should complete before the ‘current’ iteration of the loop can be executed. Phrased differently, if required data is not available until a previous iteration completes then the current iteration, which depends on that required data, cannot execute. The present technique introduces one or more mechanisms in which, regardless of the data dependency, the previously described parallelisation can still take place.

In some examples, the loop-carried data dependency is a read-after-write data dependency in respect of the resource. That is, the resource is written in one iteration of the loop and the resource is read in a later iteration of the loop. The value that is read in the later iteration of the loop is therefore derived from (or actually is) the value that is written in the earlier iteration.

In some examples, the decoder circuitry is responsive to: a first hint instruction configured to indicate, when executed in the first micro-thread, an availability of the resource, and a second hint instruction configured to indicate, when executed in the second micro-thread, a requirement of the resource. The first hint instruction is used to indicate that the resource is available. This can take place after the resource has been written, for instance. The second hint instruction is used to indicate, that the resource is required. This can take place before the resource has been read, for instance. By using the two instructions across the loop iterations, it is possible to signal across the iterations that a resource is desired/provided.

In some examples, the resource is one of: a register, a variable, a memory location, and a block of code. By treating a block of code as a resource, it is possible to control access to that code so that only one micro-thread can be within the block at a time. This can be used to avoid race conditions between micro-threads for instance. Variables could be stored in memory for instance. This adds a further level of complication since it may not be known at compile time as to whether there is a dependency due to the dynamic nature of memory accesses. By supporting dependencies through memory, it is possible to improve the parallelism of the micro-threads.

In some examples, in dependence on a condition being met, the decoder circuitry is responsive to the second hint instruction by creating a virtual dependency; and in dependence on the condition being met, the decoder circuitry is responsive to the first hint instruction by resolving the virtual dependency. The dependency can be used to control how the hint instructions are treated by the micro-architecture. The virtual dependency makes it possible to control an order of execution of the instructions and other instructions on which those instructions depend.

In some examples, the virtual dependency is a virtual dependency on a register. Regardless of the nature of the resource, a virtual dependency (e.g. between the hint instructions and therefore other instructions on which the hint instructions depend) can itself depend on a register. That is, the hinting mechanism that exists is implemented on the basis of a register while in practice the register may simply indicate the availability (or not) of another resource such as a variable or a block of code.

In some examples, the register is a physical register. A physical register is one that is backed by a physical device. This is different from a logical/architectural register, which is a notional (virtual) register. Typically an instruction will refer to an architectural register, which indicates how registers are logically interrelated to one another. Rename circuitry is responsible for mapping architectural registers to physical registers and, at a time of execution, replacing the references to architectural registers with references to physical registers in order to remove false instruction dependencies.

In some examples, the data processing apparatus comprises: mailbox circuitry configured to store resources that have been made available, wherein the first hint instruction is prevented from being issued until there is spare capacity in the mailbox circuitry; in response to issuing the first hint instruction, a new entry is inserted into the mailbox circuitry in respect of the resource; the second hint instruction is unable to be issued until a corresponding entry for the resource is present in the mailbox circuitry; and in response to the second hint instruction being completed, the corresponding entry for the resource is deleted from the mailbox circuitry. The mailbox circuitry can be used for implementing the virtual dependencies. In particular, when the first hint instruction is issued (which requires the mailbox circuitry to have spare capacity), it causes a new entry to be inserted into the mailbox circuitry to indicate the availability of the resource that is specified by the first hint instruction. The second hint instruction cannot be executed until the resource that is mentioned by the second hint instruction is listed in the mailbox circuitry (thereby indicating its availability). When the second hint instruction has completed (e.g. the execution is finished), the entry for the resource is deleted from (which can include being invalidated in) the mailbox circuitry thus undoing the ‘availability’ of the resource (marking it as unavailable once more). Later instructions within each micro-thread that make reference to the same resource are prevented from being issued due to their dependence on the resource. Other instructions, not dependent on the resource, may be free to execute and thus a limited form of parallelisation can take place. In some examples, the second hint instruction is unable to be issued until a corresponding entry for the resource from a previous iteration is present in the mailbox circuitry. Where multiple micro-threads are waiting for the resource, the availability is indicated to the micro-thread having the previous epoch ID (the epoch ID is allocated to each micro-thread to reflect the sequential order in the original program of the code being executed by that micro-thread).

In some examples, the virtual dependency is resolvable only as a consequence of the first hint instruction being executed. That is, there is no other way for the resource to become available other than through the first hint instruction. This makes it possibly to rigidly control the resource so that one iteration of the loop can only use the resource when it has been explicitly indicated as being available by a prior iteration.

In some examples, the decoder circuitry is responsive to a reattach instruction in a particular micro-thread of instructions to indicate an availability of each resource used by that particular micro-thread of instructions to a newer micro-thread of the instructions, and to terminate the particular micro-thread of instructions. As a failsafe mechanism, when no explicit first hint instruction is provided, the act of reattaching a particular micro-thread (e.g. ending the parallelism of the particular micro-thread) acts as an implicit first hint instruction for all resources used by that micro-thread. That is to say that if a resource is not explicitly made available by a micro-thread that is executing for iteration N of a loop, then all resources used in that micro-thread are indicated as being available for an iteration >N in the loop. Note that in some embodiments, the resources would be made available to an iteration N+1, i.e. a next iteration of the loop.

In some examples, in dependence on the condition not being met, the decoder circuitry is responsive to the first hint instruction and the second hint instruction by generating a no operation signal. Where the condition is not met, the hint instructions can simply have no effect by being decoded as for a no-operation instruction. The hint instructions therefore need not be followed and indeed can even be ignored completely. In some embodiments, there may be a number of different conditions, all of which need to be met, in order for the hint instructions to be executed as something other than a no operation instruction.

In some examples, the condition is whether parallelisation of the plurality of micro-threads is permitted. For example, the micro-architecture might have disabled or may not be able to support micro-threads. In this situation, the micro-thread instructions can simply be ignored. Such control can simply be determined by a register or a bit in a register. In some cases, parallelism might be disabled if, for instance, the overhead of implementing it is particularly high.

In some examples, the data processing apparatus comprises: register check circuitry configured to respond to a stale register value being obtained by setting a stale register flag; and the decoder circuitry is responsive to a reattach instruction in a particular micro-thread of instructions to determine whether the stale register flag is set and in response to the stale register flag being set, to cause the particular micro-thread of instructions to be re-executed. In such embodiments, rather than explicitly making a resource available and explicitly indicating a desire for a resource, and providing a mechanism by which the demand and supply hints can be joined together, the system simply assumes that the desired resource will be available. In many situations, this is not an unreasonable assumption. After all, it is possible that a micro-thread for each iteration of the loop will be created sequentially. It is therefore likely that the instructions in an earlier iteration of the loop that provide the data needed by a later iteration of the loop will have already executed. In these examples, the register check circuitry determines whether a stale register value has been accessed—i.e. a register value that is not up-to-date given the sequential ordering of the program. When this happens, and when the micro-thread is terminated (e.g. through the reattach instruction), the situation is detected and the micro-thread is made to execute again. In this situation, it is now more likely that the correct value will be stored in the register and so when the micro-thread executed, it will take the correct value. Note that, as in other embodiments, the value stored in a register can be used to enforce control over another resource, such as a value stored in memory or even a block of code.

In accordance with another example configuration there is provided a data processing apparatus comprising: input circuitry configured to receive input code comprising a loop; output circuitry configured to produce output code comprising the loop; and processing circuitry configured to generate the output code based on the input code, wherein the processing circuitry is configured to generate, within a body of the loop in the output code: a first hint instruction configured to indicate an availability of a resource, and a second hint instruction configured to indicate a requirement of the resource; and the loop comprises a loop-carried data dependency in respect of a resource that extends across iterations of the loop.

In these examples, the data processing apparatus could take the form of a compiler (which could be a just-in-time compiler) or even a part of a pipeline that dynamically processes incoming instructions in order to provide hints to a later part of the pipeline. Here, the code, which could take the form of source code, byte code, assembly code, or even processor instructions, is provided to the input circuitry. The code contains a loop. The loop body contains a series of instructions that are repeatedly executed. Each iteration of the loop may contain slightly different parameters. The processing circuitry is used to modify at least some of the input code so as to produce output code. The output code also contains the loop, albeit possibly in a different format. The loop itself has a loop-carried data dependency in respect of a resource. The dependency carries across iterations of the loop. That is, the data required for one iteration of the loop is provided by another iteration of the loop. The processing performed by the processing circuitry includes the introduction of two hint instructions in the output code—one that indicates availability of the resource and another that indicates a requirement of the resource.

In some examples, the loop-carried data dependency is a read-after-write data dependency in response of the resource. Thus, in one iteration of the loop, the resource is written and in a later iteration of the loop the resource is read. The writing of the resource in the earlier iteration therefore affects the parameter that is used by the later iteration of the loop.

In some examples, the processing circuitry is configured to place the second hint instruction prior to or at a first usage of the resource in the body of the loop; and the processing circuitry is configured to place the first hint instruction at or after a final usage of the resource in the body of the loop. By placing the first hint instruction at such a location, the second instruction that indicates the desire for the resource will occur before the resource is used within the body of the loop. Similarly by placing the second hint instruction prior to or at a first usage of the resource in the body, the first instruction that indicates the availability of the resource will occur once the resource has finished being provided. In some embodiments, the second hint instruction comes prior to or at a first time the resource is read in the loop. Also in some embodiments, the first hint instruction comes after or at the final time the resource is written in the loop. Note that the hint instruction may be provided ‘at’ a particular occasion if, for instance, an instruction performs multiple functions. For instance, a particular instruction might write the resource at the same time as indicating the resource's availability-thus acting as a first hint instruction.

In some examples, the processing circuitry is configured to place the second hint instruction and the first hint instruction such that at least part of the body of the loop is outside a region defined between the first hint instruction and the second hint instruction. For instance, the entirety of the loop body may not fall within the first hint instruction and the second hint instruction. It is this movement of instructions outside the region defined between the two hint instructions that makes it possible for parallelisation to occur well. In particular, even though a particular micro-thread may not be able to execute code that falls within the region (due to the resource being unavailable), it may still be possible to execute instructions outside that region while the resource becomes available. As a consequence, parallelisation can take place. Note that in some embodiments, the first hint instruction and the second hint instruction are placed so as to minimise a number of the instructions in the loop that are between the first hint instruction and the second hint instruction. This of course will create the greatest potential for parallelisation since it not only minimises the number of operations that must be performed in one micro-thread before the resource becomes available to another micro-thread, but it also increases the number of instructions that can be performed in a micro-thread while waiting for the resource to be made available by another micro-thread.

Particular embodiments will now be described with reference to the figures.

FIG. 1 schematically illustrates a data processing apparatus 10 which may embody various examples of the present techniques. The data processing apparatus 10 comprises multithreaded processing circuitry 12 and thread control circuitry 14. The thread control circuitry 14 is adapted to support a plurality of micro thread contexts 16. The multithreaded processing circuitry 12 is a set of multithreaded execution resources and comprises a plurality of execution pipelines 18, a set of physical registers 20, an instruction cache 22, a level 1 data cache 26 and a level 2 cache 24. Each of the plurality of execution pipelines comprises fetch circuitry 28 to fetch instructions from the instruction cache 22. The fetched instructions are passed to decode circuitry 30, which generates control signals for the other components of the multithreaded processing circuitry including the thread control circuitry 14 and to rename circuitry 32. The rename circuitry 32 maps a number of physical registers 20 to a corresponding set of architectural registers associated with the execution context that is executing on the pipeline 18 before passing the decoded instructions to issue circuitry 43 for issuing to the execute circuitry 36, which may contain any number of execution stages including, but not limited to, arithmetic logic units, floating point units and load/store units. Once the instructions have completed execution they are passed to writeback circuitry 40. It would be readily apparent to the person skilled in the art that the pipeline of components 28, 30, 32, 34, 36, and 40 is intended to be illustrative of a typical multithreaded data processing apparatus and that any pipeline components may be dedicated components provided for each pipeline or may be shared amongst any number of the plurality of pipelines 18. For example, each pipeline 18 may have some dedicated pipeline components and some components that are shared with one or more other pipelines 18. However, additional structures not explicitly shown may be added to the data processing apparatus 10. It would be readily apparent to the person skilled in the art that multithreaded processing circuitry 12 may also include a single pipeline 18 that interleaves its resources across the plurality of micro-thread contexts.

FIG. 2 schematically illustrates details of the operation of thread control circuitry 14 which may embody various examples of the present techniques. In some embodiments this thread control circuitry 42 may provide the thread control circuitry 14 of FIG. 1. The thread control circuitry 42 stores a number of counters that are used to control and keep track of the different micro threads executing on the data processing apparatus 10. In particular, the thread control circuitry 42 uses epoch counters 44 to track, for a set of currently executing code denoted by a (detach, reattach) pair of instructions (identified by a region identifier), the oldest epoch identifier issued to a micro thread with that region identifier and the youngest epoch identifier issued to a micro thread with that region identifier. In this way, and as will be further described in relation to FIG. 3A, the in-flight epoch identifiers can be maintained for each region identifier. In addition, the thread control circuitry 42 may maintain an execution context table 46 indicative of each execution context that is currently maintained by the multithreaded processing apparatus, the corresponding epoch identifier and the corresponding region identifier. It would be readily apparent to the person skilled in the art that the information illustrated as maintained in the execution context table 46 is not exhaustive and any information associated with the execution context may also be stored therein. For example, the execution context table 46 may maintain a mapping between the physical registers and architectural registers assigned to each execution context. In addition, the thread control circuitry maintains runtime data 48 based on indicative of a performance metric relating to the processing operations. Runtime data may be continually updated based on the currently executing instructions and/or may be maintained independently for each region identifier. In this way the thread control circuitry can control and maintain whether, for each region identifier, additional micro threads are to be spawned and, if micro threads are to be spawned, which epoch identifiers are associated with which execution context and which region identifier.

FIGS. 3A and 3B schematically illustrate details of the assignment of epoch identifiers which may embody various examples of the present techniques. Starting with FIG. 3A, the epoch identifiers 50 are handled in a circular way. The thread control circuitry assigns epoch identifiers in ascending order as new micro threads are spawned and wraps around when the largest supported epoch identifier is reached. This scheme is implemented using two counters which keep track of the oldest epoch identifier 52 and the youngest epoch identifier 54. When a new epoch identifier is assigned the youngest epoch identifier is incremented, wrapping around to zero once the oldest epoch identifier has been assigned. When a micro thread is committed, which occurs in-order, the oldest epoch identifier is incremented thereby freeing the epoch identifier to be used by a subsequent micro thread. As illustrated in FIG. 2, a youngest epoch counter 54 and an oldest epoch counter 52 are maintained for each region identifier.

As illustrated in FIG. 3B, for embodiments in which nested parallelisation regions are supported, the epoch identifier 56 associated with each micro thread may be defined hierarchically. In the illustrated embodiment the epoch identifier 56 is defined by an outermost identifier 58 associated with outermost pair of (detach, reattach) instructions, an outer identifier 60 defined by an outer pair of (detach, reattach) instructions nested within the outermost pair of (detach, reattach) instructions, an inner identifier 62 associated with an inner pair of (detach, reattach) instructions nested within the outer pair of (detach, reattach) instructions, and an innermost identifier 64 associated with an innermost pair of (detach, reattach) instructions nested within the inner pair of (detach, reattach) instructions. It would be readily apparent to the person skilled in the art that the definition of four layers of epoch identifiers associated with the nested pairs of (detach, reattach) instructions is for illustrative purpose only and that any number of sets of nested pairs of (detach, reattach) instructions could be supported based on the described mechanism. In some embodiments the bit-width assigned to each of the layers of epoch identifiers may be varied dynamically by the hardware at runtime, whilst in other embodiments the bit-width assigned to each of the layers of epoch identifiers may be statically determined. Similarly to the example discussed in relation to FIG. 3A, each of the outermost identifier 58, the outer identifier 60, the inner identifier 62 and the innermost identifier 64 maintains of a pair of counters associated with the oldest epoch identifier and the youngest epoch identifier. In particular, the outermost epoch identifier 58 is one of a set of available outermost identifiers 66 and is associated with an oldest outermost identifier 68 and a youngest outermost identifier 70. Similarly, assignment of each of the outer identifier 60, the inner identifier 62, and the innermost identifier 64 is maintained through a corresponding outer oldest identifier and an outer youngest identifier, an inner oldest identifier and an inner youngest identifier, and an innermost oldest identifier 74 and an innermost youngest identifier 76.

FIGS. 4 and 5 schematically illustrates details of examples of micro-thread execution which may embody various examples of the present techniques. In particular, these figures are based on the following example C code with the corresponding assembly code:

| // C code | |
|---|---|
| void sum_arrays(int *restrict res,const int *restrict a,const | |
| int *restrict b,size_t n) { | |
| for (size_t i = 0; i < n; ++i) | |
| res[i] = a[i] + b[i]; | |
| } | |
| // Optimized assembly code | |
| .text | |
| .globl | sum_arrays |
| sum_arrays: | |
| cbz | x3, exit |
| mov | x10, xzr |
| loop_head: | |
| ldr | w8, [x1, x10, lsl #2] |
| ldr | w9, [x2, x10, lsl #2] |
| add | x10, x10, #1 |
| add | w8, w9, w8 |
| str | w8, [x0, x10, lsl #2] |
| cmp | x10, x3 |
| b.ne | loop_head |

exit:
ret

In the illustrated examples the following modifications are made by the compiler to the assembly code in order to exploit the task level parallelisation set out in some embodiments of the present invention.

| // Modified assembly code with detach/reattach/sync | |
|---|---|
| instructions | |
| .text | |
| .globl | sum_arrays |
| sum_arrays: | |
| cbz | x3, exit |
| mov | x10, xzr |
| loop_head: | |
| detach | loop_body, loop_cont, <region_id>, <metadata> |
| loop_body: | |
| ldr | w8, [x1, x10, lsl #2] |
| ldr | w9, [x2, x10, lsl #2] |
| add | w8, w9, w8 |
| str | w8, [x0, x10, lsl #2] |
| reattach | loop_cont, <region_id> |
| loop_cont: | |
| add | x10, x10, #1 // moved to continuation block |
| cmp | x10, x3 |
| b.ne | loop_head |
| sync | <region_id> |

exit:
ret

The detach instruction used in the above modified assembly code comprises a number of inputs. The loop_body and loop_cont fields are the addresses of detach and continuation blocks of instructions respectively. This can be encoded using program counter based offsets for representing such addresses. The detach block field can be omitted if it corresponds to the instruction following the detach instruction in program order. The region_id field is the region identifier which must be unique at runtime and associated with the particular annotated region. In practice it is sufficient for the region identifier to be unique only within a region nest, meaning that the same region identifier could be reused across different nests. The metadata field may capture extra information that can be passed to the thread control circuitry. In particular, the metadata could be used to: encode a parallelisation confidence level, representing the likelihood of dynamic dependencies materialising at runtime, e.g. based on profiling data; encoding a parallelisation worthiness level, e.g. by including additional information about the estimate length of the parallel paths, expressed in a number of instructions, which could include both a best case and a worst case instruction count; and other information relating to the types of expected dependencies in the region such as the presence or absence of read after write hazards. Similarly, the reattach instruction specifies the loop_cont address and the region identifier, and the sync instruction specifies the region identifier.

FIG. 4 schematically illustrates details of an example of micro-thread execution which may embody an example of the present technique. In particular, the thread executing the detach instruction (uthread 0, initially) continues execution from loop_body without changing its epoch identifier. The spawned micro thread (uthread 1, initially) begins execution from loop_cont with a newly allocated epoch identifier to reflect the fact that, in the original serial program, the continuation path would have been executed after the detach path in program order. In this case uthread 0 continues (assuming successful execution with no data hazards) until it reaches the reattach instruction and uthread 1 begins at the continuation address, increments the value stored in the register x10 by 1, compares the value stored in x10 to that in x3 and updates the condition flags based on the result before branching to loop_head. Execution of uthread 1 continues from loop_head with the issuing of the detach instruction which spawns micro thread uthread 2 before execution of uthread 1 continues from loop_body (assuming successful execution with no data hazards) until it reaches the reattach instruction. As illustrated the spawning of a new micro thread by each previous micro thread continues until the conditional flags associated with the b.ne instruction indicate that the zero flag is set, i.e., the value held in the register x10 is equal to x3. At this point execution of the micro thread that issues the sync instruction (in this case uthread n) is paused until the micro threads with the older epoch identifiers are all complete, i.e., they have successfully executed the reattach instruction.

FIG. 5 schematically illustrates details of an example of micro-thread execution which may embody various examples of the present techniques. In particular, the thread executing the detach instruction (uthread 0 in this case) continues execution starting from the continuation path (loop_cont) with a newly allocated epoch identifier to reflect the fact that, in the original serial program, the continuation path would have been executed after the detach path (loop body) in program order. The spawned micro thread (uthread 1) starts execution from the detach path (loop_body) with an epoch identifier that is inherited from the parent micro thread. In this example embodiment uthread 0 executes the instructions after loop_cont, first incrementing the value stored in x10 by 1, comparing the value in x10 to x3 and updating the condition flags based on the result before branching to loop_head and re-executing the detach instruction. This causes a new micro thread uthread 2 to be spawned and to continue from loop_body with an updated value in the register x10 imported into the execution context associated with uthread 2 from the execution context associated with uthread 0. As illustrated the spawning of microthreads by uthread 0 continues until the conditional flags associated with the b.ne instruction indicate that the zero flag is set, i.e., the value held in the register x10 is equal to x3. At this point the sync instruction is issued and execution of uthread 0 is paused until the micro threads with the older epoch identifiers are all complete, i.e., they have successfully executed the reattach instruction.

In these examples, the detach instruction causes the generation of a micro-thread The reattach instruction causes the executing micro-thread to be terminated.

It may be appropriate to provide additional mechanisms for handling more complicated dependencies for resources (e.g. registers, memory, blocks of code) using the above techniques. One situation in which this can arise is in the case of a loop where each iteration of the loop depends on data that is modified in a previous iteration of the loop. That is, the loop body contains a RAW data dependency that extends across iterations of the loop. For instance, consider the code:

```
// C code
void dataflow_example( ) {
  previous_thing( );
  uint32_t d = 17;
  for (uint32_t i = 13; i < 1024; ++i) {
    parallel_region(i);
    d = complex_update(d, i);
    parallel_region(d);
  }
  next_thing( );
}
```

In this example, the variable ‘d’ is used in the complex_update function call at each iteration. The result of the complex_update function call is then stored as the new value of the variable ‘d’, which is therefore used in the next iteration. Depending on the nature of the variable ‘d’ and particularly its storage location, handling such a read-after-write dependency is either inefficient to resolve (and hence, the use of micro-threads may be blocked) or unsolved. For instance, if the variable ‘d’ is stored within memory then the RAW dependency may be detectable and if detected may result in the younger micro-thread being squashed and restarted. This can result in every micro-thread being squashed and thus can lead to micro-threading being disabled. If the variable ‘d’ is stored in a register then the RAW dependency may not be detected, since it is usually assumed that such hazards have been removed from the code at compilation.

FIG. 6 illustrates an example of two hint instructions that help to overcome these limitations. The hint instructions indicate the availability (send) and the desire (receive) for a particular resource.

These instructions permit (where micro-threading is permitted to enable parallel execution) the propagation of a resource in the form of a register and its stored value between micro-threads (e.g. between loop iterations). When micro-threading is not permitted, the instructions are simply ignored (e.g. decoded as for NOP instructions).

In these examples, the architectural state of the micro-thread when it starts is not exactly the same as the architectural state at the end of a previous iteration. In particular, the resource (e.g. register <RegisterID> and its stored value) is not available to the later iteration and will be provided later via the receive instruction. Until the receive instruction is encountered in the micro-thread, the register cannot be read within that micro-thread. Note that other instructions not dependent on the resource can still execute. Thus, some level of parallelism can still be achieved. The send instruction thereby provides an indication that sequential program flow should wait until the resource (e.g. the register) is indicated as being available.

In contrast, the send instruction creates an indication that the resource is available. This indication is sent to the next iteration of the loop.

The value <RegionID> is a value that is used to uniquely identify a loop or other data structure and can therefore be used to disambiguate between inner and outer loops. The ID could be the program counter value of the start address of the continuation block (typically the block of code that handles loop maintenance/induction variable updates when a loop is to be repeated rather than ended) for a loop.

The parameter <MessageID> can be used to express further information, such as a unique identifier. This could be used to differentiate between returned values from a series of function calls, which might all be passed back through a specific register (e.g. x0). It could also be used for more explicit data parallelisation e.g. to rely on explicit dataflow propagation.

The <MetaData> field can be used to propagate additional information from the compiler or programmer. For instance, this might indicate the expected evolution of the variable to enable value prediction at the receive site.

The previously given example in C can therefore be translated to assembly as follows (inserting the send and receive hint instructions):

| dataflow_example( ): | // @dataflow_example( ) |
|---|---|
| stp x29, x30, [sp, #−32]! | // 16-byte Folded Spill |
| stp x20, x19, [sp, #16] | // 16-byte Folded Spill |
| mov x29, sp | |
| bl previous_thing( ) | |
| mov w19, #13 | // w19 is i |
| mov w20, #17 | // w20 is d |
| .LBB14_1: | |
| detach .continuation | |
| mov w0, w19 | |
| bl parallel_region(unsigned int) | |
| mov w1, w19 | |
| receive w20, .continuation | |
| mov w0, w20 | |
| bl complex_update(unsigned int, unsigned int) | |
| mov w20, we | |
| send w20, .continuation | |
| bl parallel_region(unsigned int) | |
| reattach .continuation | |
| .continuation: | |
| add w19, w19, #1 | |
| cmp w19, #1024 | |
| b.ne .LBB14_1 | |
| sync .continuation | // sync on loop exit |
| ldp x20, x19, [sp, #16] | // 16-byte Folded Reload |
| ldp x29, x30, [sp], #32 | // 16-byte Folded Reload |

b next_thing( )

In the above example, the send and receive instructions pass the value stored in register w20 (corresponding to variable d). As shown in the C code, the variable d is passed between iterations of the loop. Both instructions also provide “.continuation” (e.g. the program counter value of .continuation) to disambiguate between nested loops (although disambiguation in this example is unnecessary). As a consequence, a second micro-thread executing a second iteration of the loop will halt when it encounters the receive instruction until a notification is received that the resource/register w20 is available. A first micro-thread executing a first iteration of the loop ignores the receive instruction but will signal such availability when it encounters the send instruction relating to the resource/register w20. The first micro-thread can be identified as being the one with the oldest epoch ID after the very first detach for a new parallel region (the latter being identified by its unique region ID==continuation address). In practice, at the very first detach, the microarchitecture knows that there were no multiple threads active (sequential mode), so it is straightforward to identify the micro-thread that will be responsible for handling iteration 0. That information may be stored in a flag for the specific micro-thread, so that it knows that a receive should be ignored.

FIG. 7 illustrates how the above code may execute. In a first micro-thread, the detach code is executed. This results in a second micro-thread being generated with epoch ID 1. In this second micro-thread, the continuation code is executed and i is immediately updated. The update function is not shown, to reduce verbosity, but in this example, the update function would cause i (in register w19) to increment by 1 in accordance with the assembly code shown above. A check is then made to see if i is less than n (1024). If so, then the process proceeds to the detach instruction where a third micro-thread (epochID=2) is generated. The second micro-thread then continues to the header and main body of the loop. If i is greater than or equal to n, the second micro-thread runs the exit code, which causes synchronisation between the micro-threads.

At the main body of the loop, the second micro-thread (epoch ID=1) reaches the receive instruction. This instruction cannot execute (and so neither can any sequentially following instruction) because no signal has yet been received that the resource (‘d’) is available.

Meanwhile, in the first micro-thread, after executing the detach instruction, the micro-thread continues to the body of the loop. After executing the complex_update function, the send instruction is encountered to indicate that resource ‘d’ is now available. The process in which this message is communicated to the other micro-thread(s) is discussed in more detail below. The first micro-thread then enters the exit block.

Once the send instruction is executed in the first micro-thread, the receive instruction of the second micro-thread is able to execute. This in turn eventually causes the send instruction of the second micro-thread to execute, which allows the third micro-thread to progress beyond its receive instruction (and so on). Having completed the send instruction in the second micro-thread, the reattach instruction is executed, which causes the second micro-thread to exit as previously described.

It will be appreciated that this model of micro-thread generation follows that illustrated with respect to FIG. 4. The present technique, including the use of the send and receive instructions, is equally applicable to other execution models such as that illustrated with respect to FIG. 5.

FIG. 8 illustrates a data processing apparatus implementation for handling two micro-threads (threadlets). Fetch and decode circuitry 705a, 705b is provided for each of the threadlets. These fetch and decode instructions into issue queues 710a, 710b, which store the fetched and decoded instructions in program order (for instance). An instruction picker 735 picks an instruction for execution form the issue queues 710a, 710b. Input operands for the picked instructions are stored, in association with each other, in reservation stations 740a, 740b. These enable out of order execution of the instructions by storing instruction input operands and monitoring results generated by the execution pipelines for operand forwarding. The reservation stations are associated with execution units 745a, 745b (e.g. one reservation station per execution unit). Thus, when the operands for an instruction in a reservation station become available, they can be provided to the associated execution unit for execution.

Out of order execution can be achieved at each of the reservation stations via rename circuitry. As with other elements of the system 700, the rename circuitry is duplicated for each of the micro-threads that are able to execute simultaneously. There is therefore provided Architectural Register Files 715a, 715b, which illustrate non-speculative values of the architectural registers (e.g. for instructions that have successfully executed and been committed in program order, the mapping of physical registers to architectural registers). In the event of a pipeline flush, the values of the ARF are restored. Reorder Buffers 725a, 725b keeps track of the original program order of instructions that have been issued and stores the speculative result of each instruction.

When the instruction is committed, the speculative result is propagated from the ROB entry to the specified register in the ARF. Within each ROB, a commit pointer points to the entry (instruction) that is next to be committed (e.g. in program order). Meanwhile, an issue pointer points to the next location to which an instruction will be added to the ROB. Finally, Register Alias Tables 720a, 720b indicate where the latest mappings for architectural registers can be found. An entry of the RAT can point to mappings in the ARF 715a, 715b or to entries in the ROB 725a, 725b depending on whether the instruction that writes to the architectural register is committed or not respectively. False dependencies can be removed by creating a new entry in the RAT 720a, 720b for each new value being generated by an instruction. In this way, each new value generated by an instruction is stored to a new (physical) register.

An instruction that exits the execution circuitry 745a, 745b is therefore stored in the relevant ROB 725a, 725b depending on which micro-thread the instruction was being executed for. The RAT 720a, 720b will point to that instruction in the ROB until such time as the instruction is committed. At that point, the RAT for that register will point to an entry of the RAF, which provides the mapping from an architectural register to a physical register.

Only one threadlet is allowed to be globally non-speculative. When a sync instruction is executed by a micro-thread or threadlet, and all the other micro-threads or threadlets have executed a reattach instruction, the architectural states of the threadlets need to be merged. For registers, this means that the contents of the ARFs need to be merged: if a register has been written by a threadlet since its creation, then that register holds the latest value for that particular epoch, otherwise the register value for that epoch should be gathered recursively from the older micro-threads—this behaviour can be enabled by adding a write bit to the entries in the ARF that is set upon writing the corresponding register). If multiple micro-threads have therefore written to a register then the ‘true’ value of the register after the reattachment will be the value stored in the youngest micro-thread that has written to the register. Clearly if no micro-thread wrote to a register then the value of that register remains unchanged.

Within this system, the send and receive instructions make use of mailbox circuitries 730a, 730b, which are provided for each micro-thread or threadlet that executes simultaneously. When a send instruction is encountered the instruction is only able to proceed provided there is an entry available within the mailbox 720a, 730b of that micro-thread. If there is space then when the send instruction completes, a new entry is added to the mailbox of that micro-thread. The entry includes a message ID, which is indicative of the resource for which the send instruction relates. For instance, where the resource is a register, this might be the register ID. The entry also includes a message type that indicates what the resource type is. Where the resource is a register, the optional register value field makes it possible to specify the register value so that this can be passed around efficiently. Finally, a validity entry can be used to indicate whether the entry of the mailbox is valid.

As an alternative to waiting for the send instruction to complete before adding the entry, it is also possible for the entry to be added to the mailbox as part of the execution of the send instruction. In this case, it is necessary to provide further metadata to track the speculation state of the send instruction and to respond appropriately in the case of a mispeculation. Part of the response to mispeculation (e.g. following the wrong branch in branch prediction) would involve squashing instructions across threadlets. The links between send and receive pairs can be stored as an additional field within the mailbox circuitry so that instructions that are executed as a consequence of a mispredicted send instruction can also be squashed.

When a receive instruction is encountered in a younger (i.e. newer) threadlet or micro-thread, the micro-thread or threadlet stalls until an entry corresponding to the desired resource is marked as valid in the mailbox belonging to the micro-thread that is the direct ancestor micro-thread of the micro-thread that issued the receive instruction. When the receive instruction completes, the mailbox entry for the send instruction that enabled the receive instruction to be dispatched (or issued) is invalidated.

Rather than each entry of the mailbox relating to a single resource, it is also possible for the Message ID field to relate to a set of resources. One way of doing this is to implement the Message ID field as a FIFO queue, for example. This assumes that send instructions execute in program order. In this way it is possible to increase the decoupling between micro-threads/threadlets and therefore further increase parallelism.

Note that the above system 700 is one example of how the handling of multiple micro-threads or threadlets can be achieved.

In the previous assembly code example, one of the hint instructions in the form of the receive instruction was explicitly provided. However, this need not be the case. Instead, the detach instruction itself can contain the hint (e.g. in metadata of the detach instruction) that a resource will be provided at a later time. For instance:

| .LBB14_1: | |
|---|---|
| detach .continuation, {w20} | // detach with receive list |
| mov w0, w19 | |
| bl parallel_region (unsigned int) | |
| mov w1, w19 | |
| mov w0, w20 | // first use of w20: ‘recv’ |

```
  bl complex_update(unsigned int, unsigned int)
  mov w20, we
  send w20, .continuation
  bl parallel_region(unsigned int)
  reattach .continuation
```

In such examples, the first instruction that attempts to read the listed resource (w20) will stall. In this example, the instruction “mov w0, w20” will stall in the same way as described earlier. The instruction will be permitted to issue when a corresponding entry for w20 is found in the mailbox of a micro-thread of an earlier iteration.

In another variant, the receive list is provided before the loop:

| recvlist .continuation, {w20] | |
|---|---|
| .LBB14_1: | |
| detach .continuation | |
| mov w0, w19 | |
| bl parallel_region(unsigned int) | |
| mov w1, w19 | |
| mov w0, w20 | // first use of w20 - ‘receive’ |

```
  bl complex_update(unsigned int, unsigned int)
  mov w20, w0
  send w20, .continuation
  bl parallel_region(unsigned int)
  reattach .continuation
```

In yet another variant, both the send and receive instructions can be removed and an operand can be added to the instructions that make the resource available (e.g. that performs the final write to the register) and that requires the resource (e.g. that performs the first read to the register). For instance:

| .LBB14_1: | |
|---|---|
| detach .continuation | |
| mov w0, w19 | |
| bl parallel_region(unsigned int) | |
| mov w1, w19 | |
| mov w0, w20.receive | // operand annotated to receive |
| bl complex_update(unsigned int, unsigned int) | |
| mov w20.send, w0 | // operand annotated to send |

```
  bl parallel_region(unsigned int)
  reattach .continuation
```

Encountering an instruction with the .receive operand means that the instruction will be halted until the requested resource (w20) is made available, as for a receive instruction. Encountering an instruction with the .send operand means that the instruction indicates the availability to a receiving micro-thread that the specified resource (w20) is available. In this variant, there is no indication of which loop the hints belong to. It is therefore necessary to infer this information. For instance it might be assumed that such hints apply to the outer-most loop.

Up until this point, it has been mostly assumed that the resource in question is a register, identified by the register ID. However, this need not be the case and in practice it is possible to indicate the availability of and wait for the availability of other resources such as data values stored in memory or even blocks of code.

An alternative to providing dedicated mailboxes 730a, 730b as described above is for the ROBs themselves to act as mailboxes. In this situation, it is necessary for a link across micro-threads (between send/receive pairs) to be recorded. Furthermore, the send instruction is prevented from committing until the corresponding receive instruction has committed too, otherwise the register values would be lost from the ROB.

FIG. 9 illustrates two other hint instructions that can be used to indicate the availability of (signal) and desire for (wait) other resources such as memory addresses or blocks of code. As with the hint instructions illustrated in FIG. 6, these hint instructions permit (where micro-threading is permitted to enable parallel execution) the propagation of a resource identified by a Semaphore ID and its value (if any) between micro-threads (e.g. between loop iterations). When micro-threading is not permitted, the instructions are simply ignored (e.g. decoded as for NOP instructions).

The <SemaphoreID> field is used to provide an identifier to each signal/wait pair and therefore can be used to identify a particular resource. A wait instruction for a particular identifier will wait until the corresponding signal instruction (that identifies the same identifier) is executed. The wait, in this instance, prevents any following instructions from being executed until the wait is resolved. That is, the wait acts like a barrier preventing following instructions in program order from executing until it completed. This could be achieved by setting a specific flag in the ROB entry, for instance. Consequently, the semaphore can be used to not only ‘guard’ a variable, but also a critical section of code in which only one micro-thread can be executing at a time.

As with the instructions illustrated in FIG. 6, the <RegionID> field is used to uniquely identify a loop or other data structure and can therefore be used to disambiguate between inner and outer loops.

An optional <EpochDistance> value can be used to indicate that the carried dependency is not between adjacent iterations but iterations (e.g. epochs) a set distance (the EpochDistance) away. For example, in iteration n, a wait hint with an EpochDistance of 4 would indicate that the signal with a matching SemaphoreID that needs to be synchronised with is in iteration n−4 rather than n−1. Similarly, if the EpochDistance was 4 in a signal instruction in iteration n then this would indicate that the corresponding wait instruction would be in a future iteration n+4. This can therefore capture more complicated memory dependencies, such as A[i+3]=A[i]+B[i]. An EpochDistance of 0 can be used in situations where it is certain that there will be a conflict; This causes the current iteration to wait until all previous iterations have signalled (or reattached).

As with the instructions in FIG. 6, the optional <MetaData> field can be used to propagate additional information from the compiler or programmer.

For instance, consider the following code:

```
// C code
void synchronization_example( ) {
  uint32_t *x;
  previous_thing( );
  for (uint32_t i = 13; i < 1024; ++i) {
    parallel_region(i);
    if (frequently_true(x)) {
      read_modify_write(x);
    }
    parallel_region(d);
  }
  next_thing( );
}
```

In this example, the variable ‘x’ is used in the read_modify_write function call at most iterations. This causes the variable x to be read, modified, and then written back, which is therefore (potentially) used in the next iteration. Note that the function frequently_true returns true with some high likelihood and therefore read_modify_write occurs with some high frequency. In the event that read_modify_write does not occur frequently, the overhead associated with ‘guarding’ the variable might be high and this may be a condition under which the hint instructions can be disregarded. Such a situation can be monitored using resource monitoring, for instance.

The previously given example in C can therefore be translated to assembly as follows (inserting the signal and wait hint instructions):

| synchronization_example( ): | // @synchronization_example( ) |
|---|---|
| stp x29, x30, [sp, #−32]! | // 16-byte Folded Spill |
| str x19, [sp, #16] | // 8-byte Folded Spill |
| mov x29, sp | |
| bl previous_thing( ) | |
| mov w19, #13 | // w19 is i |
| .LBB17_2: | |
| detach .continuation | |
| mov w0, w19 | |
| bl parallel_region(unsigned int) | |
| wait tkn0, .continuation, 1 | |
| bl frequently_true(unsigned int*) | |
| tbz w0, #0, .LBB17_1 | |
| bl read_modify_write(unsigned int*) | |
| .LBB17_1: | |
| signal tkn0, .continuation, 1 | |
| mov w0, w19 | |
| bl parallel_region(unsigned int) | |
| reattach .continuation | |
| .continuation: | |
| add w19, w19, #1 | |
| cmp w19, #1024 | |
| b.lt .LBB17_2 | |
| .LBB17_4: | |
| sync .continuation | |
| ldr x19, [sp, #16] | // 8-byte Folded Reload |
| ldp x29, x30, [sp], #32 | // 16-byte Folded Reload |

b next_thing( )

In the above example, the signal and wait instructions signal and wait on a semaphore having an ID of tkn0 (corresponding to variable x). Both instructions also provide “.continuation” (e.g. the program counter value of .continuation) as the region ID to disambiguate nested loops (although disambiguation in this example is unnecessary). As a consequence, a second micro-thread executing a second iteration of the loop will halt when it encounters the wait instruction until a notification is received that the resource/variable tkn0 is available. A first micro-thread executing a first iteration of the loop will ignore the wait command (being the first micro-thread for the loop) and will signal availability of tkn0 when it encounters the signal instruction relating to the resource/variable tkn0.

In practice, the SemaphoreID is mapped to a register (or a part thereof). That is to say that the wait and signal hint instructions create a virtual dependency using a register.

This is illustrated with respect to FIG. 10, which shows an example of an 8-bit register (tkn) used to support 8 semaphores. The ‘signal’ hint instruction causes the corresponding semaphore (0 in this example) of the tkn register to be flipped from a 0 to 1 and the ‘wait’ hint instruction causes the reverse to occur.

The same mailboxes 730a, 730b illustrated in FIG. 8 can be used for the semaphore enforcement. Here, a special ‘type’ is given to semaphore signalling as opposed to the register signalling illustrated earlier with the semaphore ID being given instead of the register ID for the message ID. In addition, the EpochDistance parameter is taken into account to control which

FIG. 11 illustrates how the above code may execute. In a first micro-thread, the detach code is executed. This results in a second micro-thread being generated with epoch ID 1. In this second micro-thread, the continuation code is executed and i is immediately updated. The update function is not shown, to reduce verbosity, but in this example, the update function would cause i (in register w19) to increment by 1 in accordance with the assembly code shown above. A check is then made to see if i is less than n (1024). If so, then the process proceeds to the detach instruction where a third micro-thread (epochID=2) is generated. The second micro-thread then continues to the header and main body of the loop. If i is greater than or equal to n, the second micro-thread runs the exit code, which causes synchronisation between the micro-threads.

At the main body of the loop, the second micro-thread (epoch ID=1) reaches the wait instruction. This instruction cannot execute (and so neither can any sequentially following instruction) because no signal has yet been received that x (guarded by semaphore ‘tkn0’) is available.

Meanwhile, in the first micro-thread, after executing the detach instruction, the micro-thread continues to the body of the loop (ignoring the wait instruction due to being the first micro-thread). Here, we will assume that the frequently_true function always returns true. Therefore, the next operation performed in the first micro-thread is the read_modify_write operation, which is performed on variable x. At that point, the signal instruction is encountered to indicate that the resource x, guarded by semaphore ‘tkn0’ is now available. This can be achieved using the mailboxes 730a, 730b described previously. The first micro-thread then enters the exit block.

Once the signal instruction is executed in the first micro-thread, the wait instruction of the second micro-thread is able to execute. This in turn eventually causes the signal instruction of the second micro-thread to execute, which allows the third micro-thread to progress beyond its hint instruction (and so on). Having completed the signal instruction in the second micro-thread, the reattach instruction is executed, which causes the second micro-thread to exit as previously described.

It will be appreciated that this model of micro-thread generation follows that illustrated with respect to FIG. 4. The present technique, including the use of the signal and wait instructions, is equally applicable to other execution models such as that illustrated with respect to FIG. 5.

FIG. 12 illustrates a compiler 1200, which is an example of one of the claimed data processing apparatuses. The compiler could be a regular compiler or a just-in-time compiler for instance. The data processing apparatus could also be embodied as part of a pipeline, for instance. Within the compiler 1200, input circuitry receives input code, which is processed by processing circuitry 1220 to produce output code, which is output by output circuitry 1230. The input code includes blocks of instructions (which could be the same). The output code corresponds to the input code, but also includes hint the previously mentioned hint instructions to indicate dependencies. In the case of a compiler, the dependencies may be more easily seen due to an overall view of the code being seen all at the same time. One simple way to do this is to look for loops (e.g. for loops, while loops, or recursive function calls) where a particular variable is read before being written to. The nature of the code (being looped) will, in many cases, suggest a RAW dependency across iterations of the loops.

FIGS. 13A and 13B illustrate the behaviour of the compiler 1200 with respect to the placement of the hint instructions (in this case taking the form of the wait and signal instructions). In FIG. 13A, the wait instruction is placed prior to the first instruction that reads the guarded resource (x) and the signal instruction is placed after the final instruction that writes the guarded resource (x). A small block of instructions 1300 exists within the for loop that is not between the wait and signal instructions. These instructions, being prior to the wait instruction, can be executed in parallel between the micro-threads. FIG. 13B illustrates an alternative behaviour in which the previously described requirements are met, but the number of instructions between the wait and signal instructions is minimised. Consequently, the block of instructions 1310 that can be executed in parallel is expanded as compared to the example of FIG. 13A, leading to a greater parallelism that can be achieved.

FIG. 14 illustrates another mechanism that can be used for handling dependencies. This mechanism can either be used as an alternative to the previously presented mechanism. In particular, the ARFs are extended with an additional bit field 1400, 1410, which is used to indicate whether the first access to the specific register is a read (1) or not (0). If the first access to the register is a write then a RAW dependency should not be possible. During reattachment, when the micro-threads are synchronised, if a register has a stale bit asserted (1) and the same register was also written by an older micro-thread then there is a RAW dependency.

In a situation where the previous messaging system is used, using the mailboxes 730a, 730b illustrated in FIG. 8 for example, one can determine whether a message was transmitted to indicate the availability of the resource (register). This could be achieved by not allowing the removal of an entry from a mailbox 730a, 730b until reattachment occurs (providing the validity bit of that entry has also been set to 0) or by using another tracking mechanism for instance.

In a situation where the previous messaging system is not used, no dependency mechanism has been provided and so it is necessary for the younger (newer) threadlet to be re-executed. This is because the value obtained for the register is likely to have been incorrect.

FIG. 15 illustrates a pair of flow charts 1500, 1565 that show the behaviour of a compiler 1200 and data processing apparatus 10 respectively. In this particular instance, it is assumed that the mechanism described with reference to FIG. 14 is not being used.

At a step 1505, input code is received by the compiler 1200. At step 1510, the input code is processed to produce output code. This process includes, at least, adding hints to the code. Then, at a step 1515, the output code is output. The output code could be input further down the pipeline (in which case the compiler 1200 and the apparatus 10 are the same data processing apparatus) or could be output as an executable (for instance) that is later executed by the apparatus 10. In either case, at a step 1520, a next instruction is executed by the apparatus 10. If, at step 1525, the instruction is a receive or wait instruction then at step 1530, it is determined whether the specified resource has been indicated as being available. If not, the instruction's execution is halted until it becomes available. Otherwise, at step 1535, the instruction is executed and the process returns to step 1520. If the instruction is not a receive or wait instruction at step 1525, it is determined at step 1540 whether the instruction is a send or signal instruction. If so, the specified resource is indicated as being available at step 1545 and the process proceeds to step 1535. If the instruction is not a send/signal instruction then at step 1450, it is determined whether the instruction is guarded or not. In particular, it is determined whether the instruction lies between a send/receive pair or a signal/wait pair. If not, then the instruction is executed at step 1535. Otherwise, at step 1555, it is determined whether the instruction is within a signal/wait block. If so, then the flow waits at step 1560 until the resource becomes available and the process then proceeds to step 1535. Otherwise at step 1565, it is determined whether the instruction is performing a read of a guarded register. If not, then the flow proceeds to step 1535. Otherwise, the flow waits at step 1570 until the register becomes available, at which point the flow proceeds to step 1535.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, System Verilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes, additions and modifications can be effected therein by one skilled in the art without departing from the scope and spirit of the invention as defined by the appended claims. For example, various combinations of the features of the dependent claims could be made with the features of the independent claims without departing from the scope of the present invention.

1. A data processing apparatus comprising:
multithreaded processing circuitry to perform processing operations of a plurality of micro-threads, each micro-thread operating in a corresponding execution context defining an architectural state; and
decoder circuitry responsive to a first occurrence of a detach instruction to generate a first micro-thread in respect of a first block of instructions, and a second occurrence of the detach instruction to generate a second micro-thread in respect of a second block of instructions, wherein
the second block of instructions comprises a data dependency in respect of a resource accessed in the first block of instructions.

2. The data processing apparatus according to claim 1, wherein
the first block of instructions and the second block of instructions are iterations of a same loop; and
the data dependency extends across iterations of the loop.

3. The data processing apparatus according to claim 1, wherein
the data dependency is a read-after-write data dependency in respect of the resource.

4. The data processing apparatus according to claim 1, wherein
the decoder circuitry is responsive to:
a first hint instruction configured to indicate, when executed in the first micro-thread, an availability of the resource, and
a second hint instruction configured to indicate, when executed in the second micro-thread, a requirement of the resource.

5. The data processing apparatus according to claim 4, wherein
the resource is one of: a register, a variable, a memory location, and a block of code.

6. The data processing apparatus according to claim 4, wherein
in dependence on a condition being met, the decoder circuitry is responsive to the second hint instruction by creating a virtual dependency; and
in dependence on the condition being met, the decoder circuitry is responsive to the first hint instruction by resolving the virtual dependency.

7. The data processing apparatus according to claim 6, wherein
the virtual dependency is a virtual dependency on a register.

8. The data processing apparatus according to claim 7, wherein
the register is a physical register.

9. The data processing apparatus according to claim 4, comprising:
mailbox circuitry configured to store resources that have been made available, wherein
the first hint instruction is prevented from being issued until there is spare capacity in the mailbox circuitry;
in response to issuing the first hint instruction, a new entry is inserted into the mailbox circuitry in respect of the resource;
the second hint instruction is unable to be issued until a corresponding entry for the resource is present in the mailbox circuitry; and
in response to the second hint instruction being completed, the corresponding entry for the resource is deleted from the mailbox circuitry.

10. The data processing apparatus according to claim 4, wherein
the virtual dependency is resolvable only as a consequence of the first hint instruction being executed.

11. The data processing apparatus according to claim 1, wherein
the decoder circuitry is responsive to a reattach instruction in a particular micro-thread of instructions to indicate an availability of each resource used by that particular micro-thread of instructions to a newer micro-thread of the instructions, and to terminate the particular micro-thread of instructions.

12. The data processing apparatus according to claim 6, wherein
in dependence on the condition not being met, the decoder circuitry is responsive to the first hint instruction and the second hint instruction by generating a no operation signal.

13. The data processing apparatus according to claim 6, wherein
the condition is whether parallelisation of the plurality of micro-threads is permitted.

14. The data processing apparatus according to claim 1, comprising:
register check circuitry configured to respond to a stale register value being obtained by setting a stale register flag; and
the decoder circuitry is responsive to a reattach instruction in a particular micro-thread of instructions to determine whether the stale register flag is set and in response to the stale register flag being set, to cause the particular micro-thread of instructions to be re-executed.

15. A method comprising:
performing processing operations of a plurality of micro-threads, each micro-thread operating in a corresponding execution context defining an architectural state;
responding to a first occurrence of a detach instruction to generate a first micro-thread in respect of a first block of instructions; and
responding to a second occurrence of the detach instruction to generate a second micro-thread in respect of a second block of instructions, wherein
the second block of instructions comprises a data dependency in respect of a resource accessed in the first block of instructions.

16. A non-transitory computer-readable medium to store computer-readable code for fabrication of a data processing apparatus comprising:
multithreaded processing circuitry to perform processing operations of a plurality of micro-threads, each micro-thread operating in a corresponding execution context defining an architectural state; and
decoder circuitry responsive to a first occurrence of a detach instruction to generate a first micro-thread in respect of a first block of instructions, and a second occurrence of the detach instruction to generate a second micro-thread in respect of a second block of instructions, wherein the second block of instructions comprises a data dependency in respect of a resource accessed in the first block of instructions.

17. (canceled)

18. (canceled)

19. (canceled)

20. (canceled)

21. (canceled)

22. (canceled)

23. (canceled)
